(19) United States
(12) Patent Application Publication
(10) Pub. No.: US 2006/0016803 A1
(43) Pub. Date: Jan. 26, 2006

(54) Carbon heater

(75) Inventors: Wan Soo Kim, Kwangmyung-si (KR); Yang Kyeong Kim, Buchun-si (KR); Young Jun Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/184,791

(22) Filed: Jul. 20, 2005

(30) Foreign Application Priority Data
Jul. 21, 2004 (KR) 2004-56846

(51) Int. Cl. H05B 3/10

(52) U.S. Cl. 219/553

(57) ABSTRACT

Disclosed herein is a carbon heater. The carbon heater comprises a sheet-shaped carbon filament disposed in a tube. The carbon filament is arranged in the tube while being twisted. Consequently, radiant heat is uniformly emitted in all directions. Furthermore, support parts are formed at the twisted sheet-shaped carbon filament or support wires are attached to the twisted sheet-shaped carbon filament, whereby the carbon filament support structure is more secured. Consequently, the service life of the carbon heater is increased, and easy design and assembly of the carbon heater are accomplished.

### BACKGROUND OF THE INVENTION

1. Field of the Invention

The present invention relates to a carbon heater incorporating a carbon fiber or a carbon filament, which is used as a heating element, and, more particularly, to a carbon heater having a sheet-shaped carbon filament, which is disposed in a tube while being twisted, whereby uniform radiation is accomplished in all directions with a secure filament support structure.

2. Description of the Related Art

Generally, a carbon heater is a heater that uses a filament made of carbon as a heating element. As it became known that the carbon heater has excellent thermal efficiency, does not harm the environment when the carbon is discarded, and provides several effects, such as far infrared radiation, deodorization, sterilization, and antibacterial activity, the carbon heater has been increasingly used in room-heating apparatuses and drying apparatuses as well as heating apparatuses.

FIG. 1 is a perspective view schematically illustrating a conventional helical carbon heater, and FIG. 2 is a longitudinal sectional view of principal components of the conventional helical carbon heater illustrated in FIG. 1.

As shown in FIGS. 1 and 2, the conventional carbon heater comprises: a quartz tube 10 whose interior is hermetically sealed by tube sealing parts 11 disposed at both ends of the quartz tube 10; a helical carbon filament 12 arranged longitudinally in the quartz tube 10; metal wires 14 attached to both ends of the carbon filament 12 while extending to both ends of the quartz tube 10, respectively; and external electrodes 16 electrically connected to the metal wires 14 via metal pieces 18 disposed in the tube sealing parts 11 of the quartz tube 10, respectively, while being exposed to the outside of the quartz tube 10.

The interior of the quartz tube 10 is hermetically sealed, and the interior of the quartz tube 10 is maintained in vacuum or filled with an inert gas such that the carbon filament is not oxidized at a temperature of 250 to 300° C.

The carbon filament 12 is formed in a helical shape, and the metal wires 14 are connected to both ends of the carbon filament 12, respectively.

FIG. 3 is a longitudinal sectional view illustrating principal components of another conventional carbon heater incorporating a sheet-shaped carbon filament.

As shown in FIG. 3, the conventional carbon heater comprises: a sheet-shaped carbon filament 22 disposed in a quartz tube 20; carbon rods 24, for example, cylindrical graphite bars, in which both ends of the sheet-shaped carbon filament 22 are fitted, respectively; and springs 25 connected between the carbon rods 24 and metal wires 23, respectively, for providing tension forces to the carbon filament 22.

In FIG. 3, reference numeral 26 indicates external electrodes, and reference numeral 28 indicates metal pieces connected between the external electrodes 26 and the metal wires 23, respectively.

The carbon filament is formed in a helical shape as shown in FIG. 2, or the carbon filament is formed in the shape of a sheet as shown in FIG. 3, although the carbon filament may be formed in any other shape. For example, the carbon filament may be formed in the shape of a straight line, a fabric, or a sponge.

For the helical carbon filament 12 as shown in FIG. 2, both ends of the helical carbon filament 12 are tied to the metal wires 14, respectively, such that contact resistance is reduced at the connections between both ends of the helical carbon filament and the metal wires 14. For the sheet-shaped carbon filament 22 as shown in FIG. 2, both ends of the sheet-shaped carbon filament 22 cannot be tied to the metal wires 23, respectively. For this reason, a slit is formed at each carbon rod 24 such that both ends of the sheet-shaped carbon filament 22 are fitted in the slits of the carbon rods 24, respectively. Also, the springs 25 disposed at outer ends of the carbon rods 24 apply tension forces to the carbon rods 24, and thus, the carbon filament 22.

In the carbon heater as shown in FIG. 3, however, both ends of the sheet-shaped carbon filament 22 are securely fitted in the carbon rods 24, respectively, and then the carbon rods 24 are connected to the metal wires 23 by the springs 25, respectively. As a result, the carbon filament connection structure is complicated, and therefore, the whole structure of the carbon heater is complicated. Consequently, the manufacturing costs of the carbon heater are considerably increased.

Since the carbon filament 22 of the conventional carbon heater is formed in the shape of a sheet as described above, the amount of radiation from the surfaces of the sheet-shaped carbon filament 22 is large. However, the amount of radiation from the lateral sides of the sheet-shaped carbon filament 22 is very small. As a result, the radiant energy is not uniformly emitted from the carbon heater in all directions.

Furthermore, the carbon filament 22 is tensioned by the carbon rods 24, the springs 25 and the metal wires 23 disposed at both ends of the carbon filament 22, respectively, such that the carbon filament 22 is supported in the quartz tube 20. As a result, the carbon filament 22 is lengthened after the conventional carbon heater is used for a long period of time, and therefore, the carbon filament 22 comes into contact with the inside of the quartz tube 20.

### SUMMARY OF THE INVENTION

Therefore, the present invention has been made in view of the above problems, and it is an object of the present invention to provide a carbon heater having a sheet-shaped carbon filament, which is disposed in a tube while being twisted, and, if necessary, support parts are formed at the twisted sheet-shaped carbon filament or support wires are attached to the twisted sheet-shaped carbon filament, whereby radiant energy is uniformly emitted from the twisted sheet-shaped carbon filament in all directions while a secure filament support structure is accomplished.

In accordance with the present invention, the above and other objects can be accomplished by the provision of a carbon heater comprising: a sheet-shaped carbon filament disposed in a tube, wherein the carbon filament is arranged in the tube while being twisted.

In a preferred embodiment of the present invention, the carbon filament has support parts integrally formed at the carbon filament while being protruded from the carbon filament in the direction intersecting the longitudinal direction of the carbon filament such that the support parts are supported inside the tube.

Preferably, the support parts of the carbon filament are protruded from the carbon filament while being spaced uniformly apart from one another in the longitudinal direction of the carbon filament.

Preferably, the support parts of the carbon filament are arranged in bilateral symmetry with respect to the center line of the carbon filament in the longitudinal direction of the carbon filament.

In another preferred embodiment of the present invention, the carbon filament is supported inside the tube by support wires securely attached to the carbon filament in the direction intersecting the longitudinal direction of the carbon filament.

Preferably, each of the support wires is securely inserted between a plurality of stacked carbon sheets constituting the carbon filament.

Preferably, the carbon heater further comprises: at least one connection conductor securely fitted in at least one end of the carbon filament such that the at least one connection conductor is connected to the at least one end of the carbon filament.

Preferably, the at least one connection conductor is formed in the shape of meshes.

Preferably, the at least one connection conductor is inserted between a plurality of stacked carbon sheets when the carbon filament is formed by pressing the plurality of stacked carbon sheets such that the stacked carbon sheets are securely attached to one another, and is then pressed together with the stacked carbon sheets.

In the carbon heater with the above-stated construction according to the present invention, the carbon filament is disposed in the quartz tube while being twisted. Consequently, the present invention has the effect of uniformly emitting radiant heat in all directions.

Furthermore, the support parts are formed at the twisted sheet-shaped carbon filament or the support wires are attached to the twisted sheet-shaped carbon filament, whereby a more secure filament support structure is accomplished. Consequently, the present invention has the effect of increasing the service life of the carbon heater and accomplishing easy design and assembly of the carbon heater.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view schematically illustrating a conventional helical carbon heater;

FIG. 2 is a longitudinal sectional view illustrating principal components of the conventional helical carbon heater;

FIG. 3 is a longitudinal sectional view illustrating principal components of a conventional sheet-shaped carbon heater;

FIG. 4 is a longitudinal sectional view illustrating principal components of a carbon heater according to a first preferred embodiment of the present invention;

FIG. 5 is a longitudinal sectional view illustrating principal components of a carbon heater according to a second preferred embodiment of the present invention;

FIG. 6 is a cross-sectional view taken along line A-A of FIG. 5;

FIG. 7 is a longitudinal sectional view illustrating principal components of a carbon heater according to a third preferred embodiment of the present invention; and

FIG. 8 is a cross-sectional view taken along line B-B of FIG. 7.

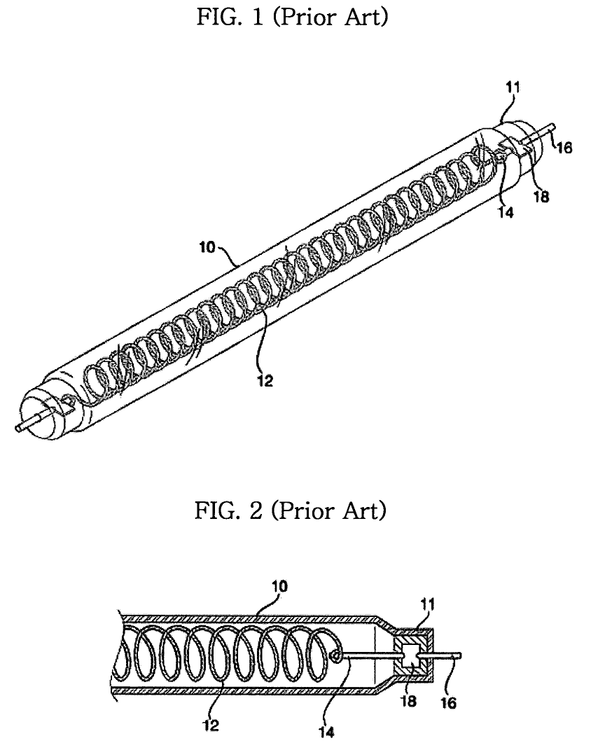

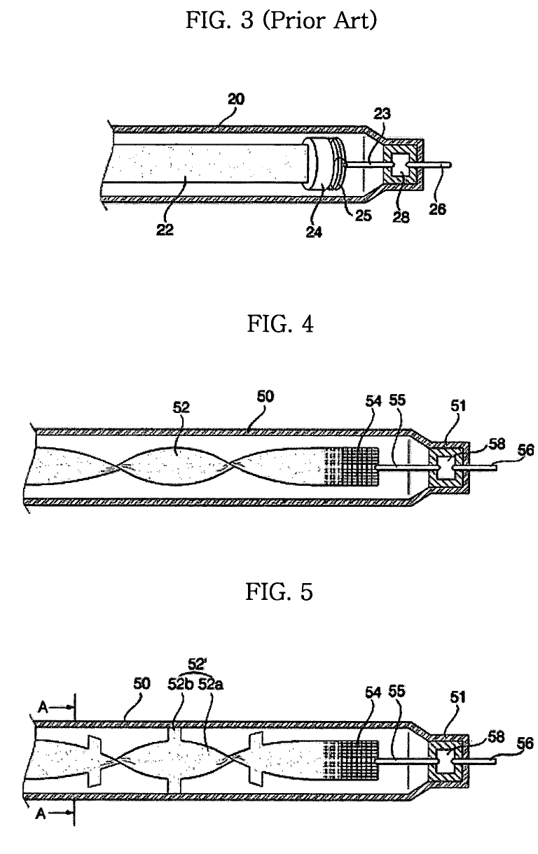

### DESCRIPTION OF THE PREFERRED EMBODIMENTS

Now, preferred embodiments of the present invention will be described in detail with reference to the accompanying drawings.

FIG. 4 is a longitudinal sectional view illustrating principal components of a carbon heater according to a first preferred embodiment of the present invention.

As shown in FIG. 4, the carbon heater according to the first preferred embodiment of the present invention comprises: a quartz tube 50 having tube sealing parts 51 formed at both ends thereof; a carbon filament 52 disposed longitudinally in the quartz tube 50 for serving as a heating element, the carbon filament 52 being formed in the shape of a twisted sheet; external electrodes 56 disposed at the tube sealing parts 51 of the quartz tube 50, respectively, while being exposed to the outside of the quartz tube 50; metal wires 55 connected to the external electrodes 56 via metal pieces 58 fixed to the tube sealing parts 51 at both ends of the quartz tube 50, respectively; and connection conductors 54 connected between both ends of the carbon filament 52 and the metal wires 55, respectively.

The quartz tube 50 is constructed such that the interior of the quartz tube 50 is hermetically sealed while the interior of the quartz tube 50 is maintained in vacuum or filled with an inert gas. Preferably, the tube is made of quartz, although materials for the tube are not restricted. For example, any tube having sufficient thermal resistance and strength, such as a special glass tube, may be used.

The carbon filament 52 is formed by pressing a plurality of stacked carbon sheets such that the stacked carbon sheets are securely attached to one another and twisting the pressed carbon sheets in a helical shape.

The metal wires 55, each made of a metal material, are securely fixed to the respective connection conductors 54, for example, by welding, such that the metal wires 55 are electrically connected to the connection conductors 54, respectively.

Each of the connection conductors 54 is a thin metal sheet formed in the shape of meshes. The connection conductors 54 are securely fitted in both ends of the carbon filament 52. In this way, the connection conductors 54 are connected to the carbon filament 52.

Specifically, each of the connection conductors 54 is inserted between a plurality of stacked carbon sheets when the carbon filament 52 is formed by pressing the plurality of stacked carbon sheets such that the stacked carbon sheets are securely attached to one another, and is then pressed together with the stacked carbon sheets. As a result, the connection conductors 54 are securely attached to both ends of to the carbon filament 52, respectively.

Now, the operation of the carbon heater with the above-stated construction according to the present invention will be described.

The carbon filament 52 is formed by pressing a plurality of stacked carbon sheets such that the stacked carbon sheets are securely attached to one another. At this time, the pressing operation of the stacked carbon sheets is carried out while the connection conductors 54 are inserted between the stacked carbon sheets at both ends of the carbon filament 52. In this way, the connection conductors 54 are securely attached to both ends of to the carbon filament 52, respectively.

After the connection conductors 54 are connected to both ends of the carbon filament 52, one of the connection conductors 54 is rotated in one direction while the other connection conductor 54 is rotated in the opposite direction. As a result, the carbon filament 52 is twisted as shown in FIG. 4. Subsequently, the metal wires 55 are securely attached to the respective connection conductors 54 of the twisted carbon filament 52, for example, by welding.

After the connection conductors 54 and the metal wires 55 are connected to both ends of the carbon filament 52, respectively, as described above, the carbon filament 52 is inserted into the quartz tube 50, and then the tube sealing parts 51 are closed such that the interior of the quartz tube 50 is hermetically sealed by the closed tube sealing parts 51. Subsequently, the external electrodes 56 are connected to the respective metal pieces 58, which are also connected to the metal wires 55, respectively. In this way, disposition of the carbon filament 52 in the quartz tube 50 is completed.

As the carbon filament 52 is disposed in the quartz tube 50 while being twisted as described above, radiant energy generated from the carbon filament is emitted in all directions of the quartz tube, and therefore, a uniform heating operation is performed.

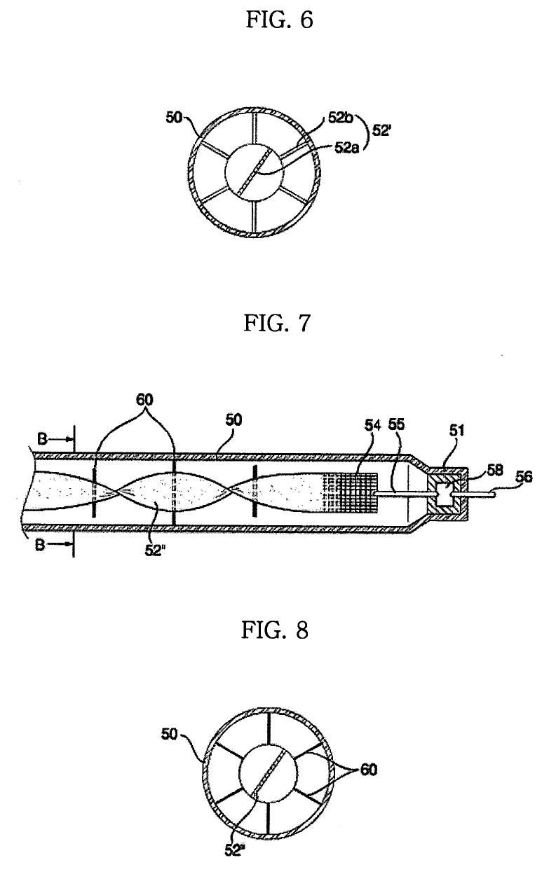

FIG. 5 is a longitudinal sectional view illustrating principal components of a carbon heater according to a second preferred embodiment of the present invention, and FIG. 6 is a cross-sectional view taken along line A-A of FIG. 5.

The carbon heater according to the second preferred embodiment of the present invention is characterized by a carbon filament 52′ having support parts 52b, which are integrally formed at the carbon filament 52′ while being protruded from the carbon filament 52′, which is distinguished from the carbon heater according to the first preferred embodiment of the present invention.

Specifically, the carbon filament 52′ comprises: a heating part 52a disposed longitudinally in the quartz tube 50, while being twisted, for performing a heating operation when the heating part 52a is supplied with electric current; and support parts 52b integrally formed at the heating part 52a while being protruded from both lateral sides of the heating part 52a in the direction intersecting the longitudinal direction of the carbon filament 52′ such that the support parts 52b are supported inside the quartz tube 50.

As the heating part 52a is disposed in the quartz tube 50 while being twisted as described above, the support parts 52b are supported at different angular positions inside the quartz tube 50. Consequently, the carbon filament support structure is more secured.

FIG. 7 is a longitudinal sectional view illustrating principal components of a carbon heater according to a third preferred embodiment of the present invention, and FIG. 8 is a cross-sectional view taken along line B-B of FIG. 7.

The carbon heater according to the third preferred embodiment of the present invention is characterized by a carbon filament 52″, to which support wires 60 are securely attached, which is distinguished from the carbon heater according to the second preferred embodiment of the present invention.

Specifically, the support wires 60 are securely attached to the carbon filament 52″, which is disposed in the quartz tube 50 while being twisted, in the direction intersecting the longitudinal direction of the carbon filament 52″ such that support wires 60 are supported inside the quartz tube 50.

Each of the support wires 60 is formed in the shape of a straight line. Preferably, each of the support wires 60 is inserted between a plurality of stacked carbon sheets when the carbon filament 52″ is formed by pressing the plurality of stacked carbon sheets such that the stacked carbon sheets are securely attached to one another, and is then pressed together with the stacked carbon sheets. Both ends of each of the support wires 60 are in contact with the inner circumferential surface of the quartz tube 50 while the carbon filament 52″ is disposed in the quartz tube 50.

Also preferably, the support wires 60 are disposed in the quartz tube 50 while being spaced uniformly apart from one another such that the carbon filament 52″ is supported inside the quartz tube 50.

As apparent from the above description, the carbon filament is disposed in the quartz tube while being twisted. Consequently, the present invention has the effect of uniformly emitting radiant heat in all directions.

Furthermore, the support parts are formed at the twisted sheet-shaped carbon filament or the support wires are attached to the twisted sheet-shaped carbon filament, whereby a more secure filament support structure is accomplished. Consequently, the present invention has the effect of increasing the service life of the carbon heater and accomplishing easy design and assembly of the carbon heater.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A carbon heater comprising:
a sheet-shaped carbon filament disposed in a tube, wherein
the carbon filament is arranged in the tube while being twisted.

2. The heater as set forth in claim 1, wherein the carbon filament has support parts integrally formed at the carbon filament while being protruded from the carbon filament in the direction intersecting the longitudinal direction of the carbon filament such that the support parts are supported inside the tube.

3. The heater as set forth in claim 2, wherein the support parts of the carbon filament are protruded from the carbon filament while being spaced uniformly apart from one another in the longitudinal direction of the carbon filament.

4. The heater as set forth in claim 2, wherein the support parts of the carbon filament are arranged in bilateral symmetry with respect to the center line of the carbon filament in the longitudinal direction of the carbon filament.

5. The heater as set forth in claim 1, wherein the carbon filament is supported inside the tube by support wires securely attached to the carbon filament in the direction intersecting the longitudinal direction of the carbon filament.

6. The heater as set forth in claim 5, wherein each of the support wires is securely inserted between a plurality of stacked carbon sheets constituting the carbon filament.

7. The heater as set forth in claim 1, further comprising:
at least one connection conductor securely fitted in at least one end of the carbon filament such that the at least one connection conductor is connected to the at least one end of the carbon filament.

8. The heater as set forth in claim 7, wherein the at least one connection conductor is formed in the shape of meshes.

9. The heater as set forth in claim 7, wherein the at least one connection conductor is inserted between a plurality of stacked carbon sheets when the carbon filament is formed by pressing the plurality of stacked carbon sheets such that the stacked carbon sheets are securely attached to one another, and is then pressed together with the stacked carbon sheets.

10. A carbon heater comprising:
a tube;
a sheet-shaped carbon filament disposed in a tube, while being twisted, for serving as a heating element; and
at least one connection conductor securely fitted in at least one end of the carbon filament, the at least one connection conductor being connected to at least one metal wire, which is electrically connected to at least one external electrode.

11. The heater as set forth in claim 10, wherein the carbon filament has support parts integrally formed at the carbon filament while being protruded from the carbon filament in the direction intersecting the longitudinal direction of the carbon filament such that the support parts are supported inside the tube.

12. The heater as set forth in claim 11, wherein the support parts of the carbon filament are protruded from the carbon filament while being spaced uniformly apart from one another in the longitudinal direction of the carbon filament.

13. The heater as set forth in claim 12, wherein the support parts of the carbon filament are arranged in bilateral symmetry with respect to the center line of the carbon filament in the longitudinal direction of the carbon filament.

14. The heater as set forth in claim 10, wherein the carbon filament is supported inside the tube by support wires securely attached to the carbon filament in the direction intersecting the longitudinal direction of the carbon filament.

15. The heater as set forth in claim 14, wherein each of the support wires is securely inserted between a plurality of stacked carbon sheets constituting the carbon filament.

16. The heater as set forth in claim 10, wherein the at least one connection conductor is formed in the shape of meshes.

17. The heater as set forth in claim 16, wherein the at least one connection conductor is inserted between a plurality of stacked carbon sheets when the carbon filament is formed by pressing the plurality of stacked carbon sheets such that the stacked carbon sheets are securely attached to one another, and is then pressed together with the stacked carbon sheets.

18. A carbon heater comprising:
a quartz tube having tube sealing parts formed at both ends thereof;
a carbon filament disposed longitudinally in the quartz tube for serving as a heating element, the carbon filament being formed in the shape of a twisted sheet;
external electrodes disposed at the tube sealing parts of the quartz tube, respectively, while being exposed to the outside of the quartz tube;
metal wires connected to the external electrodes via metal pieces fixed to the tube sealing parts at both ends of the quartz tube, respectively; and
connection conductors connected between both ends of the carbon filament and the metal wires, respectively.

19. The heater as set forth in claim 18, wherein the carbon filament has support parts integrally formed at the carbon filament while being protruded from the carbon filament in the direction intersecting the longitudinal direction of the carbon filament such that the support parts are supported inside the tube.

20. The heater as set forth in claim 18, wherein the carbon filament is supported inside the tube by support wires securely attached to the carbon filament in the direction intersecting the longitudinal direction of the carbon filament.
